(19) United States
(12) Patent Application Publication
(10) Pub. No.: US 2026/0353346 A1
(43) Pub. Date: Nov. 5, 2026

(54) POSITIONING METHOD AND POSITIONING APPARATUS

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/538,872

(22) Filed: Feb. 12, 2026

Related U.S. Application Data
(63) Continuation of application No. PCT/CN2023/114786, filed on Aug. 24, 2023.

(51) Int. Cl. H04W 64/00; G06T 7/73

(52) U.S. Cl. CPC H04W 64/00; G06T 7/73; G06T 2207/30244

(57) ABSTRACT

A positioning method includes: acquiring a first positioning result of a device to be positioned. The first positioning result is determined using a positioning technique based on a mobile communication network; acquiring a second positioning result of the device. The second positioning result is determined using a visual positioning technique; and fusing the first positioning result and the second positioning result, so as to obtain a target positioning result of the device.

### CROSS-REFERENCE TO RELATED APPLICATIONS

This application is a continuation of International Application No. PCT/CN2023/114786, filed on Aug. 24, 2023, the disclosure of which is hereby incorporated by reference in its entirety.

### TECHNICAL FIELD

The present disclosure relates to the fields of communication technologies, and more specifically, to a positioning method and a positioning apparatus.

### BACKGROUND

Visual positioning technology may capture images through visual sensors, and may analyze and process the captured images for positioning. Therefore, visual positioning technology has advantages such as short time required, low power consumption, and convenient maintenance. However, visual positioning technology is significantly subjected to environmental impacts. For example, in weak-light situations or when the device to be positioned is obscured, the accuracy of visual positioning may be severely affected or even the visual positioning results become unavailable. Thus, how to achieve high-accuracy positioning is an urgent problem to be solved.

### SUMMARY

The present disclosure provides a positioning method and a positioning apparatus. Various aspects of the present disclosure are described below.

In a first aspect, a positioning method is provided. The method includes: obtaining a first positioning result of a device to be positioned, the first positioning result being determined with a mobile communication network-based positioning technology; obtaining a second positioning result of the device to be positioned, the second positioning result being determined with a visual positioning technology; and fusing the first positioning result and the second positioning result to derive a target positioning result of the device to be positioned.

In a second aspect, a positioning apparatus is provided. The apparatus includes: a first obtaining module, obtaining a first positioning result of a device to be positioned, the first positioning result being determined with a mobile communication network-based positioning technology; a second obtaining module, obtaining a second positioning result of the device to be positioned, the second positioning result being determined with a visual positioning technology; and a fusion module, fusing the first positioning result and the second positioning result to derive a target positioning result of the device to be positioned.

In a third aspect, a positioning apparatus is provided, including a processor and a memory, wherein the memory is configured to store one or more computer programs, and the processor is configured to execute the computer programs stored in the memory to cause the positioning apparatus to perform some or all of the steps of the method according to the first aspect.

In a fourth aspect, an embodiment of the present disclosure provides a communication system, including the positioning apparatus described above. In an alternative implementation, the system may further include other devices interacting with the positioning apparatus according to the solutions provided in the embodiments of the present disclosure.

In a fifth aspect, an embodiment of the present disclosure provides a computer-readable storage medium storing computer programs which, when executed by a computer, cause the computer to perform some or all of the steps of the method according to the first aspect.

In a sixth aspect, an embodiment of the present disclosure provides a computer program product, including a non-transitory computer-readable storage medium storing computer programs, wherein the computer programs are operable to cause a computer to perform some or all of the steps of the method according to the first aspect. In some implementations, the computer program product may be a software installation package.

In a seventh aspect, an embodiment of the present disclosure provides a computer program, where the computer program is operable to cause a computer to perform some or all of the steps of the method according to the first aspect.

In an eighth aspect, an embodiment of the present disclosure provides a chip including a memory and a processor, where the processor may invoke and execute computer programs from the memory to perform some or all of the steps of the method according to the aspects described above.

According to the embodiments of the present disclosure, a first positioning result determined with a mobile communication network-based positioning technology can be fused with a second positioning result determined with a visual positioning technology to derive a target positioning result. That is, according to the embodiments of the present disclosure, positioning is performed by fusing the mobile communication network-based positioning technology and the visual positioning technology, thereby mitigating limitations of visual positioning only and improving the accuracy of positioning.

### BRIEF DESCRIPTION OF THE DRAWINGS

FIG. 1 is an exemplary diagram of an architecture of a wireless communication system to which embodiments of the present disclosure are applicable.

FIG. 2 is a schematic diagram of positioning measurement based on the communication system shown in FIG. 1.

FIG. 3 is an exemplary diagram of an architecture of a positioning system to which embodiments of the present disclosure are applicable.

FIG. 4 is a schematic flowchart of a positioning method according to an embodiment of the present disclosure.

FIG. 5 is a schematic flowchart of a positioning method according to another embodiment of the present disclosure.

FIG. 6 is a schematic structural diagram of a positioning apparatus according to an embodiment of the present disclosure.

FIG. 7 is a schematic structural diagram of a communication apparatus according to an embodiment of the present disclosure.

### DETAILED DESCRIPTION OF THE EMBODIMENTS

The technical solutions of the present disclosure will be described below with reference to the accompanying drawings.

### Communication System Architecture

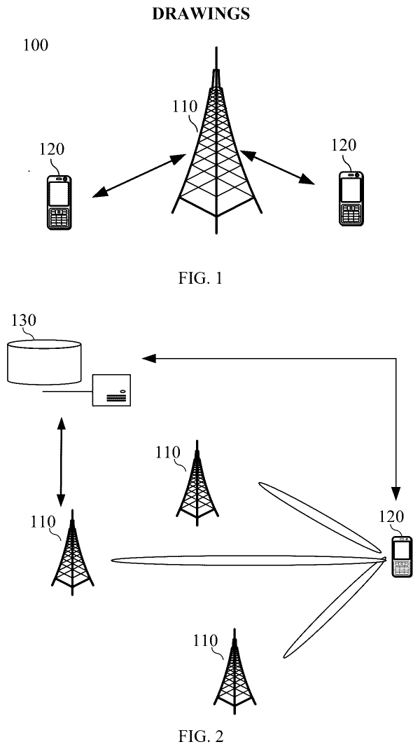

FIG. 1 is an exemplary diagram of an architecture of a wireless communication system 100 to which embodiments of the present disclosure are applicable. The wireless communication system 100 may include a network device 110 and a terminal device 120. The network device 110 may be a device that communicates with the terminal device 120. The network device 110 may provide communication coverage for a particular geographic area and may communicate with the terminal device 120 located within the coverage.

FIG. 1 exemplarily illustrates one network device and two terminal devices. Optionally, the wireless communication system 100 may include a plurality of network devices and other number of terminal devices may be included within the coverage of each network device, which is not limited in the embodiments of the present disclosure.

Optionally, the wireless communication system 100 may further include other network entities such as a network controller, or a mobility management entity, which is not limited in the embodiments of the present disclosure.

It should be understood that the technical solutions in the embodiments of the present disclosure are applicable to various communication systems, such as 5th Generation (5G) systems or New Radio (NR), Long Term Evolution (LTE) systems, LTE Frequency Division Duplex (FDD) systems, and LTE Time Division Duplex (TDD) systems. The technical solutions provided in the present disclosure may further be applied to future communication systems, such as 6th generation mobile communication systems, and satellite communication systems.

The terminal device in the embodiments of the present disclosure may also be referred to as a user equipment (UE), an access terminal, a subscriber unit, a subscriber station, a mobile site, a mobile station (MS), a mobile terminal (MT), a remote station, a remote terminal, a mobile device, a user terminal, a terminal, a wireless communication device, a user agent, or a user apparatus. The terminal device in the embodiments of the present disclosure may be a device that provides voice and/or data connectivity to users, facilitating connections among people, objects, and machines, such as handheld devices or vehicle-mounted devices with wireless connectivity. The terminal device in the embodiments of the present disclosure may be a mobile phone, a tablet computer (Pad), a laptop computer, a handheld computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, or a wireless terminal in a smart home. Optionally, the UE may be configured to act as a base station. For example, the UE may act as a scheduling entity that provides sidelink signals between UEs in V2X or D2D communication. For example, a cellular phone and an automobile communicate with each other with sidelink signals. A cellular phone and a smart home device communicate with each other without relaying communication signals through a base station.

The network device in the embodiments of the present disclosure may be a device for communicating with the terminal device. The network device may also be referred to as an access network device or a wireless access network device. For example, the network device may be a base station. The network device in the embodiments of the present disclosure may be a radio access network (RAN) node (or device) that connects terminal devices to a wireless network. The base station may broadly encompass various of the following, or may be interchangeable with one of the following, such as a NodeB, an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard radio (MSR) node, a home base station, a network controller, an access node, a radio node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node or the like, or a combination thereof. The base station may also be a communication module, a modem, or a chip provided in the device or apparatus described above. The base station may also be device that functions as a base station in a mobile switching center and device-to-device (D2D), vehicle-to-everything (V2X), and machine-to-machine (M2M) communications, a network-side device in a 6G network, or a device that functions as a base station in a future communication system, etc. The base station may support networks of the same or different access technologies. The specific technologies and specific implementation forms of the network device are not limited in the embodiments of the present disclosure.

The base station may be fixed or mobile. For example, a helicopter or drone may be configured to act as a mobile base station, and one or more cells may move based on the location of the mobile base station. In other examples, a helicopter or drone may be configured to serve as a device for communicating with another base station.

In some deployments, the network device in the embodiments of the present disclosure may be a CU or a DU, or the network device includes a CU and a DU. The gNB may further include an AAU.

The network device and terminal device may be deployed on land, including indoors or outdoors, handheld or vehicle-mounted; or on water; or on airplanes, balloons, and satellites in the air. The scene in which the network device and the terminal device are located is not limited in the embodiments of the present disclosure.

It should be understood that all or part of the functionality of the communication device in the present disclosure may also be implemented by software functionality running on hardware or by virtualization functionality instantiated on a platform (e.g., a cloud platform).

### Mobile Communication Network-Based Positioning Technology

Referring to FIG. 2, the communication system 100 may further include a positioning device 130. The positioning device 130 may be configured to determine positioning information of a terminal device. The positioning device 130 may be located in a core network. The positioning device 130 may sometimes also be referred to as a positioning server. Taking NR systems as an example, the positioning device 130 may be a location management function (LMF). Taking other communication systems as an example, the positioning device 130 may be a location management unit (LMU), a location management center (LMC), or an evolved serving mobile location center (E-SMLC). It is appreciated that the positioning device 130 may also be other network elements, nodes, or devices for determining location information of the terminal device, such as network elements or nodes for determining location information of the terminal device in a future communication system. The name of the positioning device is not specifically limited in the embodiments of the present disclosure.

Mobile communication network-based positioning technologies may include uplink positioning, downlink positioning, and sidelink positioning. The following describes mobile communication network-based positioning technologies by taking uplink positioning and downlink positioning as an example.

Certain communication systems (e.g., NR systems) perform downlink positioning based on a positioning reference signal (PRS). The PRS may also be referred to as a downlink positioning reference signal (DL-PRS), which is a reference signal for positioning functionality. For example, during downlink positioning, the terminal device 120 may first measure the PRS transmitted by a serving cell and neighboring cells (or referred to as adjacent cells) and estimate positioning measurement-related information. Subsequently, the terminal device 120 may report the positioning measurement-related information as a measurement result of the PRS to the positioning device 130. The positioning device 130 may calculate the location of the terminal device 120 based on the positioning measurement-related information reported by the terminal device 120, thereby deriving the location information of the terminal device 120. For example, the positioning device 130 may calculate the location information of the terminal device 120 based on trilateration or triangulation.

Certain communication systems (e.g., NR systems) perform uplink positioning based on an SRS. For example, during uplink positioning, the terminal device 120 transmits an SRS. The network device 110 (the network device of the serving cell and the network device of neighboring cells) may obtain a measurement result based on the SRS transmitted by the terminal device 120. The measurement result of the SRS may include positioning measurement-related information. Subsequently, the network device 110 may transmit the positioning measurement-related information to the positioning device 130. The positioning device 130 may calculate the location of the terminal device 120 based on the positioning measurement-related information reported by the network device 110, thereby deriving the location information of the terminal device 120. For example, the positioning device 130 may calculate the location information of the terminal device 120 based on trilateration or triangulation.

The positioning measurement-related information may include one or more of the following: time information, distance information, power information, and angle information. More specifically, the positioning measurement-related information may include one or more of the following: time difference of arrival (TDOA), angle difference of arrival (ADOA), reference signal received power (RSRP), etc.

Visual positioning technology may capture images through visual sensors, and may analyze and process the captured images for positioning. Therefore, visual positioning technology has advantages such as short time required, low power consumption, and convenient maintenance. For example, visual positioning with a camera has become a widely adopted technology.

However, visual positioning technology also has many issues. For example, visual positioning technology is significantly subjected to environmental impacts, resulting in the accuracy of visual positioning being severely affected or even the visual positioning result becoming unavailable. As an example, in weak-light situations, images captured by visual sensors may not be clear, resulting in low accuracy of positioning. As another example, in the presence of occlusion, there may be issues such as the visual sensor failing to detect the device to be positioned or having blind spots, resulting in visual positioning results being unavailable.

With the development of sensor networks and the Internet of Things, indoor positioning services have become a key focus of current research. However, in indoor positioning scenarios, the aforementioned issues are even more prominent.

Thus, how to achieve high-accuracy positioning is an urgent problem to be solved.

As a possible implementation, mobile communication network-based positioning technologies may be used for positioning, e.g., 5G positioning technology may be used for positioning. However, in indoor positioning scenarios, the mobile communication network-based positioning technology is also subjected to objects such as indoor obstacles or walls, resulting in signal attenuation and multipath effects between the device to be positioned and the anchor device, which leads to a decrease in accuracy of positioning as well. Similar issues may arise when other single positioning technology is used for positioning.

As another possible implementation, fusion positioning technology may be applied for positioning to compensate for the shortcomings of using a single positioning technology. For example, related technologies (e.g., 3rd Generation Partnership Project (3GPP) Release 17 (R17)) refer to fusion positioning technology, primarily referring to its configuration methods and the establishment of application layer sessions during fusion. By way of example, 3GPP TS 22.261, 3GPP TS 22.104, and 3GPP TS 22.125 study the fusion or combination of different positioning technologies to enhance performance of the positioning technology and meet the needs of vertical applications. Based on evaluating on existing positioning architectures, functional entities, and capabilities, related technologies mainly focus on whether and how to improve the positioning architecture or how to establish a new architectural model. Research in related technologies specifically includes the following aspects: (1) supporting integrated use and fusion of different positioning technologies at the application layer; (2) improvements to the positioning architecture need to consider flexibility, scalability, and reliability; (3) providing fusion positioning technology to adapt to new service requirements and evolving application needs; (4) improvements to the positioning architecture need to comply with national, local, and regional positioning privacy requirements; (5) edge computing capabilities may be used when performing fusion positioning technology.

Based on the above, according to the embodiments of the present disclosure, positioning is performed by fusing mobile communication network-based positioning technology and visual positioning technology, or in other words, according to the embodiments of the present disclosure, a collaborative positioning technology integrating visual positioning and mobile communication network-based positioning is used, which may largely mitigate limitations of visual positioning only and improve the accuracy of positioning. The reason for adopting a positioning technology that fuses mobile communication network-based positioning and visual positioning is that visual positioning technology has advantages such as strong real-time performance, short time required, low power consumption, and convenient maintenance, while mobile communication network-based positioning technology may use currently deployed network devices for positioning, providing extensive coverage and high accuracy of positioning, thereby mitigating limitations of low positioning accuracy of visual positioning technology due to being subjected to environmental impacts such as occlusion and light t. Furthermore, the fusion of these two positioning technologies does not require installation of a large number of additional hardware devices, nor modifications to existing hardware devices, causing it easy to be applied extensively. The fusing positioning technology offers significant advantages and promising application prospects in high-accuracy positioning scenarios (e.g., high-accuracy indoor positioning scenarios).

For ease of understanding, the positioning system to which the embodiments of the present disclosure are applicable is first exemplarily described.

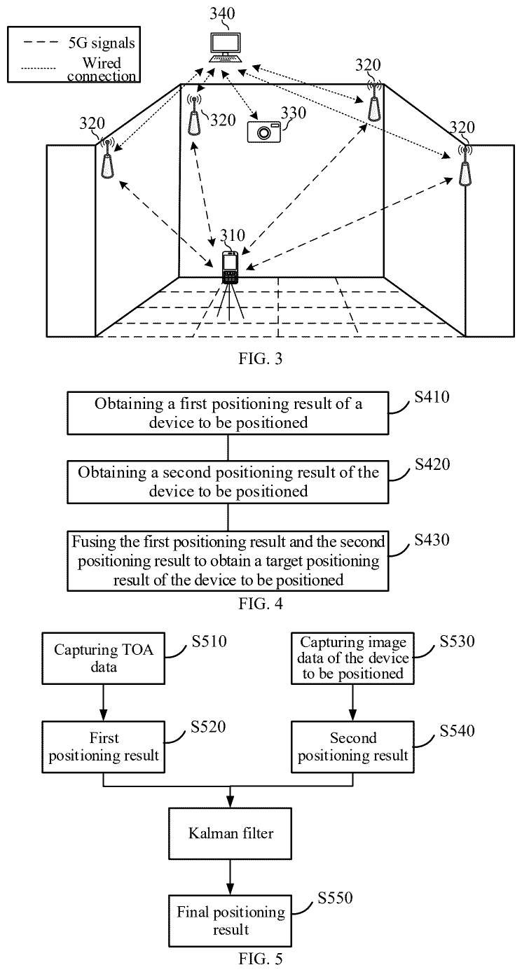

FIG. 3 is an exemplary diagram of an architecture of a positioning system according to an exemplary embodiment of the present disclosure. As shown in FIG. 3, the positioning system 300 may include a device to be positioned 310, an anchor device 320, a visual sensor 330, and a server 340.

The device to be positioned 310 refers to a device whose location needs to be determined. In some embodiments, the device to be positioned 310 may also be referred to or understood as a tag. The device to be positioned 310 is not limited in the embodiments of the present disclosure, which may be any device requiring positioning. As an example, the device to be positioned 310 may be a terminal device, such as the terminal device 120 shown in FIG. 1 or FIG. 2. As another example, the device to be positioned 310 may be an Internet of Things device or the like.

The anchor device 320 may assist the device to be positioned 310 in positioning. The location of the anchor device 320 is generally known or determined, so that the location of the device to be positioned 310 may be determined based on the location of the anchor device 320 and measurement results between the anchor device 320 and the device to be positioned 310.

The anchor device 320 is not specifically limited in the embodiments of the present disclosure, provided that the anchor device 320 may assist the device to be positioned 310 in positioning. As an example, the anchor device 320 may be a network device (e.g., a base station), such as the network device 110 shown in FIG. 1 or FIG. 2. In this case, the device to be positioned 310 and the anchor device 320 may position the device to be positioned 310 based on uplink positioning or downlink positioning. As another example, the anchor device 320 may be a terminal device, such as the terminal device 320 shown in FIG. 1 or FIG. 2. In this case, the device to be positioned 310 and the anchor device 320 may position the device to be positioned 310 based on sidelink positioning.

In some embodiments, there may be a plurality of anchor devices 320. For example, the positioning system 300 may include three or more anchor devices 320 to achieve accurate positioning of the device to be positioned 310 based on measurement results between the device to be positioned 310 and different anchor devices 320.

In some embodiments, the device to be positioned 310 and the anchor device 320 may communicate based on a mobile communication network, or in other words, the device to be positioned 310 and the anchor device 320 may communicate based on mobile communication network signals. For example, the device to be positioned 310 and the anchor device 320 may communicate based on 4G, 5G, or future mobile communication networks.

In some embodiments, the anchor device 320 may be a positioning reference unit (PRU) as defined in the related art. In some embodiments, the PRU may also be referred to as a positioning reference apparatus.

In some embodiments, the PRU at a known location may perform positioning measurement (e.g., TOA measurement) and transmit a measurement report to a positioning server (or referred to as a location server, such as an LMF).

In some embodiments, the positioning server may compare the measurement values of the PRU with expected measurement values at the known PRU location to determine correction terms for other target devices (e.g., the device to be positioned 310). Subsequently, the position measurement values of other target devices may be corrected based on the correction terms. In some embodiments, from the perspective of the positioning server, the functionality of the PRU may be implemented by a terminal device at a known location.

The visual sensor 330 may be configured to capture images of the device to be positioned 310, such as images of the device to be positioned 310 as well as the surrounding environment, so that a server subsequently determines the location of the device to be positioned 310 based on the images captured by the visual sensor. The visual sensor 330 is not specifically limited in the embodiments of the present disclosure, provided that it can capture images of the device to be positioned 310. As an example, the visual sensor 330 may be a camera. As another example, the visual sensor may be an infrared sensor or an attitude sensor.

The server 340 may perform data analysis and processing to determine the positioning result of the device to be positioned 310. For example, the server 340 may be configured to analyze and process the positioning data captured by the device to be positioned 310 and the anchor device 320, and/or analyze and process the image data captured by the visual sensor 330, and fuse the positioning results based on different positioning technologies to derive a final positioning result of the device to be positioned 310.

In some embodiments, the server 340 may also be referred to or understood as a data processing device or data processing terminal.

The server 340 is not limited in the embodiments of the present disclosure. In some embodiments, the server 340 may be a standalone server. In some embodiments, the server 340 may be a server group, such as a centralized server group or a distributed server group. In some embodiments, the server 340 may operate on a cloud platform.

The manner in which the server 340 is connected to other devices is not limited in the embodiments of the present disclosure. For example, the device to be positioned 310 may be connected to the server 340 in a wired (e.g., USB interface) or wireless (e.g., WiFi, Bluetooth) manner to provide the captured positioning data to the server 340. For another example, the anchor device 320 may be connected to the server 340 in a wired (e.g., network cable, optical fiber) or wireless (e.g., WiFi, Bluetooth, mobile network) manner to provide the captured positioning data to the server 340. For yet another example, the visual sensor 330 may be connected to the server 340 in a wired (e.g., USB interface, network cable) or wireless (e.g., WiFi, Bluetooth) manner to provide the captured image data to the server 340.

Based on the description of the positioning system applicable to the present disclosure, the positioning method according to the present disclosure is described below.

FIG. 4 is a schematic flowchart of a positioning method according to an embodiment of the present disclosure. The method shown in FIG. 4 may be performed by a device with data analysis and processing capabilities, or in other words, the method shown in FIG. 4 may be performed by a server, such as the server 340 shown in FIG. 3.

The positioning method provided in the embodiments of the present disclosure may be applied to various positioning scenarios, which is not limited in the present disclosure. For example, the positioning method may be applied to indoor positioning scenarios. Alternatively, the positioning method may be applied to outdoor positioning scenarios. Alternatively, the positioning method may be applied to positioning scenarios in which obstructions or the like are present.

The method shown in FIG. 4 may include steps S410 to S430, which are described below.

In step S410, a first positioning result of a device to be positioned is obtained.

In some embodiments, the first positioning result is determined with a mobile communication network-based positioning technology. In other words, the first positioning result is associated with the mobile communication network-based positioning technology.

The mobile communication network-based positioning technology is not limited in the embodiments of the present disclosure. By way of example, the mobile communication network-based positioning technology may include 5G positioning technology, that is, according to the embodiments of the present disclosure, the first positioning result may be determined with 5G positioning technology. However, the embodiments of the present disclosure are not limited thereto. The mobile communication network-based positioning technology may also be 4G positioning technology or a mobile communication network-based positioning technology involved in a future communication system (e.g., 6G positioning technology).

In some embodiments, the mobile communication network-based positioning technology may include signal strength-based positioning, such as RSRP-based positioning. In some embodiments, the mobile communication network-based positioning technology may include time of arrival-based positioning, such as TOA-based positioning. In some embodiments, the mobile communication network-based positioning technology may include fingerprint database-based positioning.

In some embodiments, the first positioning result is determined based on positioning data captured by the device to be positioned and an anchor device. For example, the device to be positioned and the anchor device may capture positioning data using the mobile communication network-based positioning technology. For example, the device to be positioned and the anchor device may communicate using 5G signals to exchange data to obtain positioning data.

In some embodiments, the device to be positioned and the anchor device may capture positioning data with uplink positioning. By way of example, the device to be positioned may transmit an SRS, and the anchor device (e.g., a plurality of network devices) may obtain a measurement result based on the SRS transmitted by the device to be positioned. The measurement result of the SRS may include the positioning data.

In some embodiments, the device to be positioned and the anchor device may capture positioning data with downlink positioning. By way of example, the device to be positioned may measure a DL-PRS transmitted by the anchor device (e.g., a plurality of network devices) and estimate the positioning data based on the measurement result of the DL-PRS.

In some embodiments, the device to be positioned and the anchor device may capture positioning data with sidelink positioning. By way of example, the device to be positioned may measure an SL-PRS transmitted by the anchor device (e.g., a plurality of terminal devices) and estimate the positioning data based on the measurement result of the SL-PRS. Alternatively, the device to be positioned may transmit an SL-PRS, and the anchor device (e.g., a plurality of terminal devices) may obtain a measurement result based on the SL-PRS transmitted by the device to be positioned. The measurement result of the SL-PRS may include the positioning data.

The positioning data captured by the device to be positioned and the anchor device is not limited in the embodiments of the present disclosure. In some embodiments, the positioning data captured by the device to be positioned and the anchor device may include time of arrival (TOA), or in other words, the positioning data may be obtained with TOA positioning method. However, the embodiments of the present disclosure are not limited thereto. For example, the positioning data may include one or more of the following: TDOA, ADOA, angle of arrival (AOA), etc. In other words, the positioning data may be obtained with one or more of the following positioning methods: TDOA, ADOA, AOA, etc.

In some embodiments, after obtaining the positioning data (e.g., TOA data), the device to be positioned or the anchor device may transmit the positioning data to a server.

In some embodiments, the server obtaining the first positioning result may include that the server determines the first positioning result based on the positioning data transmitted by the device to be positioned or the anchor device. However, the embodiments of the present disclosure are not limited thereto. In some embodiments, the server obtaining the first positioning result may also include that the server obtains the first positioning result from another device (e.g., an LMF).

In some embodiments, the first positioning result is determined based on a Newton's method (or referred to as a Newton's iteration method). The Newton's method can achieve rapid convergence. Thus, determining the first positioning result with the Newton's method can improve the computational speed while ensuring the accuracy of the result. Details of how to determine the first positioning result based on the Newton's method will be described later and is not elaborated here.

The embodiments of the present disclosure are not limited to determining the first positioning result using the Newton's method. For example, the embodiments of the present disclosure may determine the first positioning result using one or more of the following: Lagrange interpolation method, Gaussian elimination method, gradient descent method, quasi-Newton method, etc.

In step S420, a second positioning result of the device to be positioned is obtained.

In some embodiments, the second positioning result is determined with a visual positioning technology. In other words, the second positioning result is associated with the visual positioning technology.

As an implementation, a visual sensor (e.g., a camera) may capture an image of the device to be positioned and transmit the captured image data to a server to determine the second positioning result.

As another implementation, the visual sensor may capture an image of the device to be positioned and transmit the captured image data to another device (e.g., a terminal device associated with the visual sensor), so that the another device determines the second positioning result.

In some embodiments, the server obtaining the second positioning result may include that the server determines the second positioning result based on the image data transmitted by the visual sensor. Details of how the server determines the second positioning result based on the image data transmitted by the visual sensor will be described later and is not elaborated here. However, the embodiments of the present disclosure are not limited thereto. In some embodiments, the server obtaining the second positioning result may also include that the server obtains the second positioning result from another device (e.g., a terminal device associated with the visual sensor).

Related parameters for the image of the device to be positioned captured by the visual sensor are not limited in the embodiments of the present disclosure. Taking a rate at which the visual sensor captures an image of the device to be positioned as an example, the visual sensor may capture the image of the device to be positioned at a rate of 25 frames per second, or certainly, at any other suitable rate. Taking the size of the image of the device to be positioned captured by the visual sensor as an example, a size of the image of the device to be positioned captured each time by the visual sensor may be 1280*720 pixels, or certainly, any other suitable size.

In step S430, the first positioning result and the second positioning result are fused to obtain a target positioning result of the device to be positioned.

In some embodiments, fusing the first positioning result and the second positioning result to obtain the target positioning result of the device to be positioned may be understood as determining the target positioning result of the device to be positioned based on the first positioning result and the second positioning result, or determining an optimal estimated value of the positioning result of the device to be positioned based on the first positioning result and the second positioning result. The estimated value is the target positioning result of the device to be positioned.

The implementation of fusing the first positioning result and the second positioning result to obtain the target positioning result of the device to be positioned is not limited in the embodiments of the present disclosure. By way of example, a Kalman filter may be used to fuse the first positioning result and the second positioning result to obtain the target positioning result. That is, in some embodiments, step S430 may include: fusing the first positioning result and the second positioning result with a Kalman filter to obtain the target positioning result of the device to be positioned. The Kalman filter may determine the optimal estimated value by minimizing variance, thereby obtaining a more accurate estimation of system states, and being beneficial for improving the precision and accuracy of the measurement.

A type of the Kalman filter is not limited in the embodiments of the present disclosure. As an example, a linear Kalman filter may be used to fuse the first positioning result and the second positioning result. As another example, a nonlinear Kalman filter may be used to fuse the first positioning result and the second positioning result. As yet another example, a discrete Kalman filter, a continuous Kalman filter, an extended Kalman filter, or an unscented Kalman filter may be used to fuse the first positioning result and the second positioning result.

Nevertheless, the embodiments of the present disclosure are not limited to fusing the first positioning result and the second positioning result with a Kalman filter to obtain the final positioning result. By way of example, according to the embodiments of the present disclosure, the first positioning result and the second positioning result may be fused with one or more of the following: particle filtering, nonlinear least squares, fusion Bayesian filtering, weighted fusion algorithms, or neural networks.

The following exemplarily describes how to fuse the first positioning result and the second positioning result with a Kalman filter.

The Kalman filter is a recursive filter for estimating system states. The current optimal coordinates of the device to be positioned (i.e., the target positioning result) may be estimated by fusing the first positioning result and the second positioning result with a Kalman filter.

In some embodiments, the Kalman filter may include two steps: prediction and correction. In this case, it may be considered that a prediction equation of the Kalman filter and a correction equation of the Kalman filter may be used to fuse the first positioning result and the second positioning result to obtain the target positioning result.

As an implementation, the prediction equation of the Kalman filter may be determined with formula (1).

$$\{ \begin{matrix}{\hat{x}}_{k} & = A {\hat{x}}_{k - 1} \\ {P}_{k} & = {AP}_{k - 1} {A}^{T} + Q\end{matrix} \qquad ( 1 )$$

where \hat{x}ₖ represents a currently estimated target positioning result, \hat{x}ₖ₋₁ represents a previously estimated target positioning result, A represents a state transition matrix corresponding to the target positioning result, A^{T} represents a transpose matrix of the state transition matrix, Pₖ represents an error covariance matrix for the next iteration, Pₖ₋₁ represents a current error covariance matrix, Q represents a covariance matrix of a predicted noise, and k represents a recursive order.

As an implementation, the correction equation of the Kalman filter may be determined with formula (2).

$$\{ \begin{matrix}K & = {P}_{k} {{H}^{T} ( {HP}_{k} {H}^{T} + R )}^{- 1} \\ {\hat{x}}_{k}^{′} & = {\hat{x}}_{k} + K ( {z}_{k} - H {\hat{x}}_{k} ) \\ {P}_{k} & = ( 1 - KH ) {P}_{k}\end{matrix} \qquad ( 2 )$$

where K represents a Kalman gain, Pₖ represents an error covariance matrix for the next iteration, H represents a transition matrix predicted based on measurement values, H^{T} represents a transpose matrix of the transition matrix predicted based on measurement values, R represents a covariance matrix of a measured noise, \hat{k}ₖ′ represents a corrected target positioning result, \hat{x}ₖ represents a currently estimated target positioning result, zₖ represents the first positioning result and the second positioning result, and k represents a recursive order.

As mentioned above, the first positioning result may be determined based on the Newton's method. The following describes how to determine the first positioning result based on the Newton's method.

As an implementation, the server may derive distance data between the device to be positioned and the anchor device with TOA data captured by the device to be positioned and the anchor device, and process the distance data with the Newton's method to derive the first positioning result.

In some embodiments, the distance between the device to be positioned and the anchor device may be equal to a product of the captured TOA data and the speed of light.

In some embodiments, the distance between the device to be positioned and the anchor device may be expressed by formula (3).

\sqrt{(x−xᵢ)²+(y−yᵢ)²+(z−zᵢ)²}=dᵢ (3)
where (x,y,z) represents the first positioning result (coordinates to be calculated) of the device to be positioned, (xᵢ,yᵢ,zᵢ) represents the position coordinates of the i-th anchor device, and dᵢ represents the distance between the device to be positioned and the i-th anchor device. In some embodiments, formula (3) may be transformed or rewritten into formula (4).

\sqrt{(x−xᵢ)²+(y−yᵢ)²+(z−zᵢ)²}−dᵢ=0 (4)

By setting the left side of formula (4) as fᵢ, a vector F determined based on the distances between the device to be positioned and different anchor devices may be expressed as F=[f₁, f₂, . . . , fᵢ, . . . ].

The Jacobian matrix F′ of the vector F may be determined by formula (5).

$${F}^{′} = [ \begin{matrix}\frac{\partial {f}_{1}}{\partial x} & \frac{\partial {f}_{1}}{\partial y} & \frac{\partial {f}_{1}}{\partial z} \\ \frac{\partial {f}_{2}}{\partial x} & \frac{\partial {f}_{2}}{\partial y} & \frac{\partial {f}_{2}}{\partial z} \\ \frac{\partial {f}_{3}}{\partial x} & \frac{\partial {f}_{3}}{\partial y} & \frac{\partial {f}_{3}}{\partial z} \\ ⋯ & ⋯ & ⋯\end{matrix} ] \qquad ( 5 )$$

Taking a positioning system including four anchor devices as an example, formula (4) may include the following four formulas:

\sqrt{(x−x₁)²+(y−y₁)²+(z−z₁)²}−d₁=0

\sqrt{(x−x₂)²+(y−y₂)²+(z−z₂)²}−d₂=0

\sqrt{(x−x₃)²+(y−y₃)²+(z−z₃)²}−d₃=0

\sqrt{(x−x₄)²+(y−y₄)²+(z−z₄)²}−d₄=0

By setting the left sides of the above four formulas as f₁, f₂, f₃, and f₄, respectively, the vector F may be expressed as F=[f₁, f₂, f₃, f₄], and the Jacobian matrix F′ corresponding to F may be expressed by formula (6).

$${F}^{′} = [ \begin{matrix}\frac{\partial {f}_{1}}{\partial x} & \frac{\partial {f}_{1}}{\partial y} & \frac{\partial {f}_{1}}{\partial z} \\ \frac{\partial {f}_{2}}{\partial x} & \frac{\partial {f}_{2}}{\partial y} & \frac{\partial {f}_{2}}{\partial z} \\ \frac{\partial {f}_{3}}{\partial x} & \frac{\partial {f}_{3}}{\partial y} & \frac{\partial {f}_{3}}{\partial z} \\ \frac{\partial {f}_{4}}{\partial x} & \frac{\partial {f}_{4}}{\partial y} & \frac{\partial {f}_{4}}{\partial z}\end{matrix} ] \qquad ( 6 )$$

In some embodiments, when determining the first positioning result with the Newton's method, the first positioning result may be determined based on formula (7).

x^{(k+1)}=x(k)+Δx(k) (7)
where x^{(k+1)} is the first positioning result obtained in the next iteration, x^{(k)} is the first positioning result obtained in the current iteration, Δx^{(k)} is an error updated in the current iteration, and k is the number of iterations.

The error Δx^{(k)} updated in the current iteration is determined based on formula (8).

Δx^{(k)}=(F′(x^{(k)}))⁻¹·(−F(x^{(k)})) (8)
where F(x^{(k)}) is a vector determined based on a distance between the device to be positioned and the anchor device, and (F′(x^{(k)}))⁻¹ is an inverse matrix of the Jacobian matrix of F(x^{(k)}).

It should be understood that F(x^{(k)}) may be determined based on the vector F mentioned above, and the vector (F′(x^{(k)}))⁻¹ may be determined based on formula (6) mentioned above.

In some embodiments, in addition to using the Jacobian matrix mentioned above to calculate a gradient of the objective function to determine the first positioning result, other methods may also be used to calculate the gradient of the objective function to assist in determining the first positioning result. By way of example, according to the embodiments of the present disclosure, methods such as finite difference method, automatic differentiation method, or forward difference method may be used to calculate the gradient of the objective function so as to determine the first positioning result, which is not limited in the embodiments of the present disclosure.

As mentioned above, the server may determine the second positioning result based on the image data transmitted by the visual sensor. The implementation of the server determining the second positioning result based on the image data is described below.

As an implementation, the second positioning result may be determined based on pixel coordinates of the device to be positioned. By way of example, the server may determine camera coordinates of the device to be positioned based on the pixel coordinates of the device to be positioned, and determine the second positioning result based on the camera coordinates of the device to be positioned.

The implementation of determining the pixel coordinates of the device to be positioned is not limited in the embodiments of the present disclosure. By way of example, the embodiments of the present disclosure may use a YOLO algorithm to determine the pixel coordinates of the device to be positioned. In other words, the embodiments of the present disclosure may use the YOLO algorithm to detect and identify the device to be positioned in the image, thereby deriving pixel coordinates of the device to be positioned in the image.

The YOLO algorithm is an end-to-end deep learning object detection algorithm. The YOLO algorithm may adjust the image captured by the visual sensor to 448*448 pixels, then input the adjusted image into a convolutional neural network, and finally deriving a region where the device to be positioned is located through non-maximum suppression. In some embodiments, the output of the convolutional neural network is coordinates (i,j) of an upper-left corner of the device to be positioned in the image, as well as the width w and height h of the device to be positioned. In such case, the pixel coordinates (u,v) of the device to be positioned may be determined based on formula (9).

u=i+w/2

v=j−h/2 (9)

The embodiments of the present disclosure use the YOLO algorithm to detect and identify the device to be positioned in the image, thereby improving a detection speed and a detection effect. However, the present disclosure is not limited to using the YOLO algorithm to detect and identify the device to be positioned in the image. For example, the embodiments of the present disclosure may also use other object detection algorithms such as a region-based convolutional neural network (R-CNN) detection algorithm or a feature pyramid network algorithm to detect and identify the device to be positioned in the image.

In some embodiments, the second positioning result is determined using a pixel-to-world coordinate conversion algorithm. That is, the embodiments of the present disclosure may use the pixel-to-world coordinate conversion algorithm to convert the pixel coordinates of the device to be positioned into real-world three-dimensional coordinates (i.e., the second positioning result).

In some embodiments, the second positioning result may be determined based on the camera coordinates of the device to be positioned. For example, the second positioning result may be determined based on the camera coordinates of the device to be positioned and a rigid transformation matrix. As a possible implementation, the second positioning result may be equal to the product of the camera coordinates of the device to be positioned and the rigid transformation matrix.

In some embodiments, the camera coordinates of the device to be positioned may be determined based on formula (10).

$${z}_{c} [ \begin{matrix}{x}_{p} \\ {y}_{p} \\ 1\end{matrix} ] = K [ \begin{matrix}{x}_{c} \\ {y}_{c} \\ \begin{matrix}{z}_{c} \\ 1\end{matrix}\end{matrix} ] \qquad ( 10 )$$

where (xₚ,yₚ) represents image plane coordinates, (x_{c},y_{c},z_{c}) represents the camera coordinates,

$$K = [ \begin{matrix}f & 0 & 0 & 0 \\ 0 & f & 0 & 0 \\ 0 & 0 & 1 & 0\end{matrix} ] ,$$

and f represents the camera focal length.

In some embodiments, the rigid transformation matrix may be determined based on extrinsic parameters of the camera. For example, the rigid transformation matrix may be determined based on formula (11).

$$P = [ \begin{matrix}R & T \\ 0 & 1\end{matrix} ] \qquad ( 11 )$$

where P represents the rigid transformation matrix, R represents a rotation matrix of the camera, and T represents a translation vector of the camera.

R and T are the extrinsic parameters of the camera. The implementation of obtaining the extrinsic parameters of the camera is not limited in the embodiments of the present disclosure. By way of example, the extrinsic parameters of the camera may be obtained with camera calibration methods, such as Zhang's calibration method, Tsai's calibration method, or other camera calibration methods.

In some embodiments, the camera coordinates of the device to be positioned are determined based on the pixel coordinates of the device to be positioned. The implementation of the server determining the camera coordinates of the device to be positioned based on the pixel coordinates of the device to be positioned is not limited in the embodiments of the present disclosure. By way of example, the embodiments of the present disclosure may determine image plane coordinates of the device to be positioned based on the pixel coordinates of the device to be positioned, and determine the camera coordinates of the device to be positioned based on the image plane coordinates of the device to be positioned.

As an implementation, the image plane coordinates of the device to be positioned may be determined based on formula (12).

$$[ \begin{matrix}u \\ v \\ 1\end{matrix} ] = [ \begin{matrix}\frac{1}{dx} & 0 & {u}_{0} \\ 0 & \frac{1}{dy} & {v}_{0} \\ 0 & 0 & 2\end{matrix} ] [ \begin{matrix}{x}_{p} \\ {y}_{p} \\ 1\end{matrix} ] \qquad ( 12 )$$

where (u,v) represents the pixel coordinates of the device to be positioned, (xₚ,yₚ) represents the image plane coordinates of the device to be positioned, (u₀,v₀) represents a translation of the origin of the two-dimensional pixel coordinate system, and dx and dy represent physical dimensions of each pixel along the coordinate axes.

The implementation of the server determining the camera coordinates of the device to be positioned based on the image plane coordinates of the device to be positioned is not limited in the embodiments of the present disclosure. By way of example, the server may convert the image plane coordinates of the device to be positioned into camera coordinates of the device to be positioned based on the principle of perspective projection transformation. As a specific implementation, the embodiments of the present disclosure may determine the camera coordinates of the device to be positioned based on the above formula (10).

As mentioned above, the first positioning result may be determined based on the positioning data (e.g., TOA data) captured by the device to be positioned and the anchor device, and the second positioning result may be determined based on the image data captured by the visual sensor. The relationship between the positioning data and the image data is described below.

In some embodiments, there is an association relationship (mapping relationship) between the positioning data corresponding to the first positioning result and the image data corresponding to the second positioning result. For example, there is a temporal association between the positioning data corresponding to the first positioning result and the image data corresponding to the second positioning result, or in other words, the positioning data corresponding to the first positioning result and the image data corresponding to the second positioning result are associated with each other in a time sequence.

In some embodiments, the positioning data corresponding to the first positioning result and the image data corresponding to the second positioning result may be data corresponding to the device to be positioned at the same time or within a short period of time, thereby being beneficial for ensuring the accuracy of the positioning result of the device to be positioned in a moving state. A duration of the short period of time is not limited in the embodiments of the present disclosure. For example, the short period of time may be on the order of milliseconds, provided that the device to be positioned does not move or moves only a very short distance during the short period of time, without affecting the accuracy of positioning.

As an implementation, the positioning data corresponding to the first positioning result may include time information (time label, timestamp, etc.) for capturing the positioning data, and the image data corresponding to the second positioning result may include time information for capturing the image data, such that the server may determine which data to be used for determining the target positioning result based on the respective time information, thereby improving the accuracy of the positioning result.

For ease of understanding, a specific example of the embodiments of the present disclosure is provided below with reference to FIG. 5, which is used to exemplarily describe the steps of the method embodiments of the present disclosure.

It should be noted that the example is described by taking the fusion of 5G positioning technology and visual positioning technology as an example. For portions that are not described in detail in the example, reference may be made to the foregoing description.

FIG. 5 is a schematic flowchart of a positioning method according to another embodiment of the present disclosure. The method shown in FIG. 5 is described from the perspective of interaction between various devices included in the positioning system. The method shown in FIG. 5 may include steps S510 to S550.

In step S510, a device to be positioned and/or an anchor device captures TOA data.

In some embodiments, the device to be positioned and the anchor device may communicate using 5G signals to capture or obtain TOA data.

In some embodiments, the device to be positioned or the anchor device may transmit the captured TOA data to a server, e.g., via an optical fiber.

In step S520, the server determines a first positioning result.

In some embodiments, the server may determine the first positioning result with a Newton's method.

In some embodiments, the server may determine the first positioning result with the TOA data captured by the device to be positioned or the anchor device.

In step S530, a visual sensor captures image data of the device to be positioned.

For example, the visual sensor may capture image data with a resolution of 1280*720 pixels at a rate of 25 frames per second.

In some embodiments, after obtaining the image data of the device to be positioned, the visual sensor may transmit the image data of the device to be positioned to the server, e.g., via a network cable.

In step S540, the server determines a second positioning result.

In some embodiments, the server may perform object detection on the image data transmitted by the visual sensor (i.e., detect the device to be positioned in the image) to derive pixel coordinates of the device to be positioned, and determine the second positioning result based on the pixel coordinates.

In some embodiments, the server may use a YOLO algorithm to detect and identify the device to be positioned in the image, thereby deriving the pixel coordinates of the device to be positioned in the image. Furthermore, the server may use a pixel-to-world coordinate conversion algorithm to derive the second positioning result of the device to be positioned (real-world three-dimensional coordinates of the device to be positioned).

In step S550, the server fuses the first positioning result and the second positioning result to derive a target positioning result.

As an implementation, the server may fuse the first positioning result and the second positioning result with a Kalman filter to derive the target positioning result.

The execution order of the steps in the example of FIG. 5 is not limited in the embodiments of the present disclosure. For example, step S530 may be executed after step S510, before step S510, or simultaneously with step S510. For another example, step S530 may be executed after step S520, before step S520, or simultaneously with step S520.

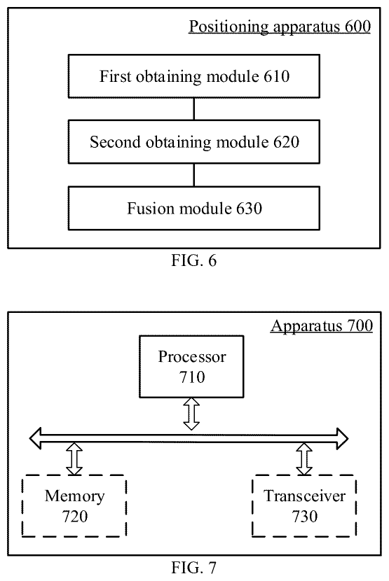

The method embodiments of the present disclosure have been described in detail above with reference to FIGS. 1 to 5. The apparatus embodiments of the present disclosure will be described in detail below with reference to FIGS. 6 and 7. It should be understood that the description of the method embodiments corresponds to the description of the apparatus embodiments, and therefore, for portions that are not described in detail, reference may be made to the foregoing method embodiments.

FIG. 6 is a schematic structural diagram of a positioning apparatus according to an exemplary embodiment of the present disclosure. The positioning apparatus 600 shown in FIG. 6 may be any server mentioned above, such as the server 340. In other words, the positioning apparatus 600 shown in FIG. 6 may be applied to any server mentioned above. For example, the positioning apparatus 600 is a component of the server 340.

The positioning apparatus 600 may include a first obtaining module 610, a second obtaining module 620, and a fusion module 630.

The first obtaining module 610 may be configured to obtain a first positioning result of a device to be positioned, where the first positioning result is determined with a mobile communication network-based positioning technology.

The second obtaining module 620 may be configured to obtain a second positioning result of the device to be positioned, where the second positioning result is determined with a visual positioning technology.

The fusion module 630 may be configured to fuse the first positioning result and the second positioning result to derive a target positioning result of the device to be positioned.

Optionally, the first positioning result is determined based on positioning data captured by the device to be positioned and an anchor device.

Optionally, the positioning data is obtained with a TOA positioning method.

Optionally, the first positioning result is determined based on a Newton's method.

Optionally, the first positioning result is determined based on the following formula: x^{(k+1)}=x^{(k)}+Δx^{(k)}, where x^{(k+1)} is the first positioning result obtained in the next iteration, x^{(k)} is the first positioning result obtained in the current iteration, Δx^{(k)} is an error updated in the current iteration, and k is the number of iterations; the error Δx^{(k)} updated in the current iteration is determined based on the following formula: Δx^{(k)}=(F′(x^{(k)}))⁻¹. (−F(x^{(k)})), where F(x^{(k)}) is a vector determined based on the distance between the device to be positioned and the anchor device, and (F′(x^{(k)}))⁻¹ is an inverse matrix of the Jacobian matrix of F(x^{(k)}).

Optionally, the second positioning result is determined based on pixel coordinates of the device to be positioned, where the pixel coordinates are derived with a YOLO algorithm.

Optionally, the second positioning result is determined based on camera coordinates of the device to be positioned and a rigid transformation matrix, where the camera coordinates are determined based on the following formula:

$${z}_{c} [ \begin{matrix}{x}_{p} \\ {y}_{p} \\ 1\end{matrix} ] = K [ \begin{matrix}{x}_{c} \\ {y}_{c} \\ {z}_{c} \\ 1\end{matrix} ] ,$$

where (xₚ,yₚ) represents the image plane coordinates, (x_{c},y_{c},z_{c}) represents the camera coordinates,

$$K = [ \begin{matrix}f & 0 & 0 & 0 \\ 0 & f & 0 & 0 \\ 0 & 0 & 1 & 0\end{matrix} ] ,$$

and f represents the camera focal length; the rigid transformation matrix is determined based on the following formula:

$$P = [ \begin{matrix}R & T \\ 0 & 1\end{matrix} ] ,$$

where P represents the rigid transformation matrix, R represents a rotation matrix of the camera, and T represents a translation vector of the camera.

Optionally, the fusion module is configured to fuse the first positioning result and the second positioning result with a Kalman filter to derive the target positioning result.

Optionally, the fusion module is configured to fuse the first positioning result and the second positioning result with a prediction equation of the Kalman filter and a correction equation of the Kalman filter to derive the target positioning result. The prediction equation is determined using the following formula:

$$\{ \begin{matrix}{\hat{x}}_{k} & = A {\hat{x}}_{k - 1} \\ {P}_{k} & = {AP}_{k - 1} {A}^{T} + Q\end{matrix} ,$$

and the correction equation is determined using the following formula:

$$\{ \begin{matrix}K & = {P}_{k} {{H}^{T} ( {HP}_{k} {H}^{T} + R )}^{- 1} \\ {\hat{x}}_{k}^{′} & = {\hat{x}}_{k} + K ( {z}_{k} - H {\hat{x}}_{k} ) \\ {P}_{k} & = ( 1 - KH ) {P}_{k}\end{matrix} ,$$

where \hat{x}ₖ represents a currently estimated target positioning result, \hat{x}ₖ₋₁ represents a previously estimated target positioning result, A represents a state transition matrix corresponding to the target positioning result, A^{T} represents a transpose matrix of the state transition matrix, Pₖ represents an error covariance matrix for the next iteration, Pₖ₋₁ represents a current error covariance matrix, Q represents a covariance matrix of a predicted noise; K represents a Kalman gain, H represents a transition matrix predicted based on measurement values, H^{T} represents a transpose matrix of the transition matrix predicted based on measurement values, R represents a covariance matrix of a measured noise, \hat{x}ₖ′ represents a corrected target positioning result, zₖ represents the first positioning result and the second positioning result, and k represents a recursive order.

Optionally, the mobile communication network-based positioning technology includes 5G positioning technology.

Optionally, the positioning method is used for indoor positioning.

Optionally, positioning data corresponding to the first positioning result includes time information for capturing the positioning data, and image data corresponding to the second positioning result includes time information for capturing the image data.

FIG. 7 is a schematic structural diagram of a communication apparatus according to an exemplary embodiment of the present disclosure. The dashed lines in FIG. 7 indicate that the unit or module is optional. The apparatus 700 may be configured to perform the method described in the foregoing method embodiments. The apparatus 700 may be a chip, a server, a terminal device, or a network device.

The apparatus 700 may include one or more processors 710. The processor 710 may support the apparatus 700 to perform the method described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, etc. The general-purpose processor may be a microprocessor, or the processor may be any conventional processor, etc.

The apparatus 700 may further include one or more memories 720. The memory 720 stores a program that may be executed by the processor 710, causing the processor 710 to perform the method described in the foregoing method embodiments. The memory 720 may be independent of the processor 710 or may be integrated into the processor 710.

The apparatus 700 may further include a transceiver 730. The processor 710 may communicate with another device or chip through the transceiver 730. For example, the processor 710 may transmit data to and receive data from another device or chip through the transceiver 730.

An embodiment of the present disclosure further provides a computer-readable storage medium for storing a program. The computer-readable storage medium may be applied to the terminal or network device provided in the embodiments of the present disclosure, and the program causes a computer to perform the method to be performed by the terminal or network device in various embodiments of the present disclosure.

An embodiment of the present disclosure further provides a computer program product. The computer program product includes a program. The computer program product may be applied to the terminal or network device provided in the embodiments of the present disclosure, and the program causes a computer to perform the method to be performed by the terminal or network device in various embodiments of the present disclosure.

An embodiment of the present disclosure further provides a computer program. The computer program may be applied to the terminal or network device provided in the embodiments of the present disclosure, and the computer program causes a computer to perform the method to be performed by the terminal or network device in various embodiments of the present disclosure.

It should be understood that the terms “system” and “network” in the present application may be used interchangeably. In addition, the terms used in the present application are merely used to explain specific embodiments of the present application and are not intended to limit the present application. In the description, claims, and accompanying drawings of the present application, the terms “first”, “second”, “third”, “fourth”, and the like are used to distinguish between different objects rather than describe a specific order. In addition, the terms “including” and “having” and any variations thereof are intended to cover non-exclusive inclusion.

In the embodiments of the present disclosure, the term “indicate” mentioned in the embodiments of the present application may be a direct indication, or may be an indirect indication, or may indicate that there is an association relationship. For example, A indicates B, which may indicate that A directly indicates B, e.g., B is obtained through A, or may indicate that A indirectly indicates B, e.g., A indicates C and B is obtained through C, or may indicate that A and B have an association relationship.

In the embodiments of the present application, the term “corresponding” may indicate that there is a direct correspondence or indirect correspondence between the two, or may indicate that there is an association relationship between the two, or may be relationships such as indicating and being indicated, configuring and being configured, etc.

In the embodiments of the present application, the terms “predefined” or “preconfigured” may be implemented by pre-storing a corresponding code, a table, or another manner that may be used to indicate related information in a device (e.g., a terminal device and a network device), and a specific implementation is not limited in the present application. For example, the predefined may indicate being defined in a protocol.

In the embodiments of the present application, the term “protocol” in the embodiments of the present application may refer to a standard protocol in the field of communications, such as an LTE protocol, an NR protocol, and related protocols applied to a future communication system, which is not limited in the present application.

In the embodiments of the present application, determining B based on A does not mean that B is determined only based on A, or B may also be determined based on A and/or other information.

In the embodiments of the present application, the term “and/or” in this specification is merely an association relationship for describing associated objects, indicating that there are three relationships, e.g., A and/or B may indicate that A exists alone, A and B exist at the same time, and B exists alone. In addition, the character “/” in this specification generally indicates an “or” relationship between the associated objects.

In various embodiments of the present application, a size of a serial number of each process does not mean an execution sequence, and the execution sequence of each process should be determined by its function and internal logic but should not constitute any limitation on an implementation process of the embodiments of the present application.

In several embodiments provided in the present disclosure, it should be understood that the disclosed system, apparatus, and method may be implemented in other ways. For example, the apparatus embodiments described above are merely illustrative. For example, the division of units is merely a logical functional division, and there may be other ways of division in actual implementation. For example, a plurality of units or components may be combined or integrated into another system, or some features may be omitted or not implemented. In addition, the displayed or discussed mutual couplings or direct couplings or communication connections may be implemented through indirect coupling or communication connection via some interfaces, devices, or units, and may be implemented in electronic, mechanical, or other forms.

The units described as separate components may or may not be physically separated, and the components displayed as units may or may not be physical units, i.e., they may be located in one place or distributed on a plurality of network units. Some or all of the units may be selected according to actual needs to achieve the purpose of the solutions of the embodiments.

In addition, the function units in various embodiments of the present disclosure may be integrated into one processing unit, or each of the units may exist alone physically, or two or more units may be integrated into one unit.

The foregoing embodiments may be implemented completely or partially by software, hardware, firmware, or any combination thereof. When implemented using software, the foregoing embodiments may be implemented completely or partially in the form of a computer program product. The computer program product includes one or more computer instructions. When the computer program instructions are loaded and executed on a computer, the procedures or functions according to the embodiments of the present disclosure are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (e.g., a coaxial cable, an optical fiber, and a digital subscriber line (DSL)) manner or a wireless (e.g., infrared, wireless, and microwave) manner. The computer-readable storage medium may be any available medium readable by a computer, or a data storage device, such as a server or a data center integrated with one or more available media. The available medium may be a magnetic medium (e.g., a floppy disk, a hard disk, or a magnetic tape), an optical medium (e.g., a digital video disc (DVD)), or a semiconductor medium (e.g., a solid-state drive (SSD)).

The foregoing descriptions are merely specific implementations of the present disclosure, but the scope of protection of the present disclosure is not limited thereto. Any changes or substitutions readily figured out by those skilled in the art within the technical scope disclosed in the present disclosure shall fall within the scope of protection of the present disclosure. Therefore, the scope of protection of the present disclosure shall be subject to the scope of protection of the appended claims.

What is claimed is:

1. A positioning method, comprising:
obtaining a first positioning result of a device to be positioned, wherein the first positioning result is determined with a mobile communication network-based positioning technology;
obtaining a second positioning result of the device to be positioned, wherein the second positioning result is determined with a visual positioning technology; and
fusing the first positioning result and the second positioning result to derive a target positioning result of the device to be positioned.

2. The method according to claim 1, wherein the first positioning result is determined based on positioning data captured by the device to be positioned and an anchor device.

3. The method according to claim 1, wherein the first positioning result is determined based on the following formula:
x^{(k+1)}=x^{(k)}+Δx^{(k)}
wherein x^{(k+1)} is the first positioning result obtained in a next iteration, x^{(k)} is the first positioning result obtained in a current iteration, Δx^{(k)} is an error updated in the current iteration, and k is the number of iterations.

4. The method according to claim 3, wherein the error Δx^{(k)} updated in the current iteration is determined based on the following formula:
Δx^{(k)}=(F′(x^{(k)}))⁻¹·(−F(x^{(k)}))
wherein F(x^{(k)}) is a vector determined based on the distance between the device to be positioned and the anchor device, and (F′(x^{(k)}))⁻¹ is an inverse matrix of the Jacobian matrix of F(x^{(k)}).

5. The method according to claim 1, wherein the second positioning result is determined based on pixel coordinates of the device to be positioned;
the second positioning result is determined based on camera coordinates of the device to be positioned and a rigid transformation matrix, the camera coordinates are determined based on the following formula:
$${z}_{c} [ \begin{matrix}{x}_{p} \\ {y}_{p} \\ 1\end{matrix} ] = K [ \begin{matrix}{x}_{c} \\ {y}_{c} \\ {z}_{c} \\ 1\end{matrix} ]$$
wherein (xₚ,yₚ) represents image plane coordinates, (x_{c},y_{c},z_{c}) represents the camera coordinates,
$$K = [ \begin{matrix}f & 0 & 0 & 0 \\ 0 & f & 0 & 0 \\ 0 & 0 & 1 & 0\end{matrix} ] ,$$
and f represents a camera focal length;
the rigid transformation matrix is determined based on the following formula:
$$P = [ \begin{matrix}R & T \\ 0 & 1\end{matrix} ]$$
wherein P represents the rigid transformation matrix, R represents a rotation matrix of the camera, T represents a translation vector of the camera, 0 represents a zero matrix and 1 represents a unit vector.

6. The method according to claim 1, wherein the fusing the first positioning result and the second positioning result to derive a target positioning result comprises:
fusing the first positioning result and the second positioning result with a Kalman filter to derive the target positioning result;
wherein the fusing the first positioning result and the second positioning result with a Kalman filter to derive the target positioning result comprises:
fusing the first positioning result and the second positioning result with a prediction equation of the Kalman filter and a correction equation of the Kalman filter to derive the target positioning result;
the prediction equation is determined with the following formula:
$$\{ \begin{matrix}{\hat{x}}_{k} & = A {\hat{x}}_{k - 1} \\ {P}_{k} & = {AP}_{k - 1} {A}^{T} + Q\end{matrix}$$
the correction equation is determined with the following formula:
$$\{ \begin{matrix}K & = {P}_{k} {{H}^{T} ( {HP}_{k} {H}^{T} + R )}^{- 1} \\ {\hat{x}}_{k}^{′} & = {\hat{x}}_{k} + K ( {z}_{k} - H {\hat{x}}_{k} ) \\ {P}_{k} & = ( 1 - KH ) {P}_{k}\end{matrix}$$
wherein \hat{x}ₖ represents a currently estimated target positioning result, \hat{x}ₖ₋₁ represents a previously estimated target positioning result, A represents a state transition matrix corresponding to the target positioning result, A^{T} represents a transpose matrix of the state transition matrix, Pₖ represents an error covariance matrix for a next iteration, Pₖ₋₁ represents a current error covariance matrix, Q represents a covariance matrix of a predicted noise; K represents a Kalman gain, H represents a transition matrix predicted based on measurement values, H^{T} represents a transpose matrix of the transition matrix predicted based on measurement values, R represents a covariance matrix of measured noise, \hat{x}ₖ′ represents a corrected target positioning result, zₖ represents the first positioning result and the second positioning result, and k represents a recursive order.

7. The method according to claim 1, wherein positioning data corresponding to the first positioning result comprises time information for capturing the positioning data, and image data corresponding to the second positioning result comprises time information for capturing the image data.

8. A positioning apparatus, comprising: a memory and a processor, wherein the memory is configured to store a computer program, and the processor is configured to execute the computer program stored in the memory to cause the positioning apparatus to perform operations comprising:
obtaining a first positioning result of a device to be positioned, wherein the first positioning result is determined with a mobile communication network-based positioning technology;
obtaining a second positioning result of the device to be positioned, wherein the second positioning result is determined with a visual positioning technology; and
fusing the first positioning result and the second positioning result to derive a target positioning result of the device to be positioned.

9. The positioning apparatus according to claim 8, wherein the first positioning result is determined based on positioning data captured by the device to be positioned and an anchor device.

10. The positioning apparatus according to claim 8, wherein the first positioning result is determined based on the following formula:
x^{(k+1)}=x^{(k)}+Δx^{(k)}
wherein x^{(k+1)} is the first positioning result obtained in a next iteration, x^{(k)} is the first positioning result obtained in a current iteration, Δx^{(k)} is an error updated in the current iteration, and k is the number of iterations.

11. The positioning apparatus according to claim 10, wherein
the error Δx^{(k)} updated in the current iteration is determined based on the following formula:
Δx^{(k)}=(F′(x^{(k)}))⁻¹·(−F(x^{(k)}))
wherein F(x^{(k)}) is a vector determined based on a distance between the device to be positioned and the anchor device, and (F′(x^{(k)}))⁻¹ is an inverse matrix of the Jacobian matrix of F(x^{(k)}.

12. The positioning apparatus according to claim 8, wherein the second positioning result is determined based on pixel coordinates of the device to be positioned;
the second positioning result is determined based on camera coordinates of the device to be positioned and a rigid transformation matrix, the camera coordinates are determined based on the following formula:
$${z}_{c} [ \begin{matrix}{x}_{p} \\ {y}_{p} \\ 1\end{matrix} ] = K [ \begin{matrix}{x}_{c} \\ {y}_{c} \\ {z}_{c} \\ 1\end{matrix} ]$$
wherein (xₚ,yₚ) represents image plane coordinates, (x_{c},y_{c},z_{c}) represents the camera coordinates,
$$K = [ \begin{matrix}f & 0 & 0 & 0 \\ 0 & f & 0 & 0 \\ 0 & 0 & 1 & 0\end{matrix} ] ,$$
and f represents a camera focal length;
the rigid transformation matrix is determined based on the following formula:
$$P = [ \begin{matrix}R & T \\ 0 & 1\end{matrix} ]$$
wherein P represents the rigid transformation matrix, R represents a rotation matrix of the camera, T represents a translation vector of the camera, 0 represents a zero matrix and 1 represents a unit vector.

13. The positioning apparatus according to claim 8, wherein the positioning apparatus is configured to:
fuse the first positioning result and the second positioning result with a Kalman filter to obtain the target positioning result;
wherein the positioning apparatus is configured to:
fuse the first positioning result and the second positioning result with a prediction equation of the Kalman filter and a correction equation of the Kalman filter to derive the target positioning result;
the prediction equation is determined with the following formula:
$$\{ \begin{matrix}{\hat{x}}_{k} & = A {\hat{x}}_{k - 1} \\ {P}_{k} & = {AP}_{k - 1} {A}^{T} + Q\end{matrix}$$
the correction equation is determined with the following formula:
$$\{ \begin{matrix}K & = {P}_{k} {{H}^{T} ( {HP}_{k} {H}^{T} + R )}^{- 1} \\ {\hat{x}}_{k}^{′} & = {\hat{x}}_{k} + K ( {z}_{k} - H {\hat{x}}_{k} ) \\ {P}_{k} & = ( 1 - KH ) {P}_{k}\end{matrix}$$
wherein \hat{x}ₖ represents a currently estimated target positioning result, \hat{x}ₖ₋₁ represents a previously estimated final positioning result, A represents a state transition matrix corresponding to the target positioning result, A^{T} represents a transpose matrix of the state transition matrix, Pₖ represents an error covariance matrix for a next iteration, Pₖ₋₁ represents a current error covariance matrix, Q represents a covariance matrix of a predicted noise; K represents a Kalman gain, H represents a transition matrix predicted based on measurement values, H^{T} represents a transpose matrix of the transition matrix predicted based on measurement values, R represents a covariance matrix of a measured noise, \hat{x}ₖ′ represents a corrected target positioning result, zₖ represents the first positioning result and the second positioning result, and k represents a recursive order.

14. The positioning apparatus according to claim 8, wherein positioning data corresponding to the first positioning result comprises time information for capturing the positioning data, and image data corresponding to the second positioning result comprises time information for capturing the image data.

15. A chip, comprising a processor that is configured to invoke a program from a memory to cause a device equipped with the chip to perform the method according to claim 1.

16. A non-transitory computer-readable storage medium, storing a program that is configured to cause a computer to perform the method according to claim 1.
